(19) United States
(12) Patent Application Publication
(10) Pub. No.: US 2019/0328061 A1
(43) Pub. Date: Oct. 31, 2019

(54) ANTI-SLIP STRUCTURE

(71) Applicant: Taiwan Paiho Limited, Chang Hwa Hsien (TW)

(72) Inventor: Allen CHENG, Chang Hwa Hsien (TW)

(21) Appl. No.: 16/154,778

(22) Filed: Oct. 9, 2018

(30) Foreign Application Priority Data
Apr. 26, 2018 (TW) 107205441

(51) Int. Cl. A41D 19/00; B62K 21/26; A41D 31/00; A63B 71/14

(52) U.S. Cl. CPC A41D 19/00; B62K 21/26; A41D 31/00; G06F 3/0395; A41D 2600/104; A41D 2400/80; A63B 71/141

(57) ABSTRACT

An anti-slip structure comprises a base sheet and a plurality of anti-slip units disposed on the base sheet at intervals in a matrix manner. Each of the anti-slip units has a central axis and comprises a top surface, a bottom surface, two side surfaces and front and back surfaces. The top surface is a planer surface having a substantial square shape that is centered on the central axis. The bottom surface is opposite to the top surface and also centered on the central axis. The two side surfaces respectively extend obliquely from two opposite side edges of the top surface outwardly toward two opposite side edges of the bottom surface, and are symmetrical to each other with respect to the central axis. The front and back surfaces respectively extend between the top and bottom surfaces and the two side surfaces.

### BACKGROUND OF INVENTION

### 1. Field of Invention

The present invention relates to an anti-slip structure, especially to an anti-slip structure that can be applied to the sports apparatus (e.g., the bicycle handlebar, the grips of various ball sticks and the like) or the lifestyle products (e.g., the mouse pad, the coaster and the like) for providing a better buffering effect and a better sense of touch.

### 2. Related Prior Art

In many different situations, in order to avoid two objects contacting with each other to move (slip) mutually so as to cause trouble in use, an anti-slip structure is commonly disposed on a contact surface of an object to provide a larger frictional force. The common anti-slip structure includes, for example, a concave-convex surface, a surface having microstructures and the like.

As one of examples, when the anti-slip structure is applied to the sports apparatus, since the use of the sports apparatus is usually subjected to the impact of the external force, if the anti-slip structure can provide a buffering effect at the same time, the user's satisfaction can be substantially improved. Moreover, since the user sometimes directly touch the anti-slip structure when using the sports apparatus, in addition to providing the anti-slip effect, it is necessary to provide a good sense of touch.

In view of above, the inventor of the present invention is motivated to research and develop a new anti-slip structure that can provide a better buffering effect and a better sense of touch in addition to providing the good anti-slip effect.

### SUMMARY OF INVENTION

An object of the present invention is to provide a new anti-slip structure that can achieve a better buffering effect and a better sense of touch by the unique design of anti-slip units thereof in addition to providing a good anti-slip effect.

Specifically, the anti-slip structure of the present invention comprises a base sheet and a plurality of anti-slip units disposed on the base sheet at intervals in a matrix manner. Each of the anti-slip units has a central axis and comprises a top surface, a bottom surface, two side surfaces and front and back surfaces. The top surface is a planer surface having a substantial square shape that is centered on the central axis. The bottom surface is opposite to the top surface and also centered on the central axis. The two side surfaces respectively extend obliquely from two opposite side edges of the top surface outwardly toward two opposite side edges of the bottom surface, and are symmetrical to each other with respect to the central axis. The front and back surfaces respectively extend between the top and bottom surfaces and the two side surfaces,

Preferably, in the anti-slip structure according to the present invention, the plurality of anti-slip units may be made of thermoplastic rubber material. More preferably, said anti-slip units may have a Shore A hardness of 38.

Preferably, in the anti-slip structure according to the present invention, the base sheet may be made of polyester material.

Preferably, in the anti-slip structure according to the present invention, each of the anti-slip units may have a height of 0.5 mm, and a side of the square shape of the top surface of each of the anti-slip units may have a length of 0.25 mm.

Preferably, in the anti-slip structure according to the present invention, the plurality of anti-slip units of the anti-slip structure are configured to be engageable with a plurality of anti-slip units of another anti-slip structure.

Further features and advantages of the present invention will become apparent after reviewing the following detailed descriptions and the accompanying drawings of the present invention.

### BRIEF DESCRIPTION OF DRAWINGS

In the drawings:

FIG. 1 is a partial schematic top view of an anti-slip structure in accordance with an embodiment of the present invention.

FIG. 2 is a schematic side view of the anti-slip structure in accordance with the embodiment of the present invention.

FIG. 3 is a schematic side view of the anti-slip structure in accordance with the embodiment of the present invention.

FIG. 4 is a schematic view of a mouse pad on which the anti-slip structure in accordance with the embodiment of the present invention is applied.

FIG. 5 is a schematic side view of the anti-slip structure in accordance with the embodiment of the present invention in which a plurality of anti-slip units thereof are engaged with a plurality of anti-slip units of another anti-slip structure.

FIG. 6 is a schematic view of a bicycle handlebar and gloves on which the anti-slip structure in accordance with the embodiment of the present invention are applied.

### DETAILED DESCRIPTION OF PREFERRED EMBODIMENT

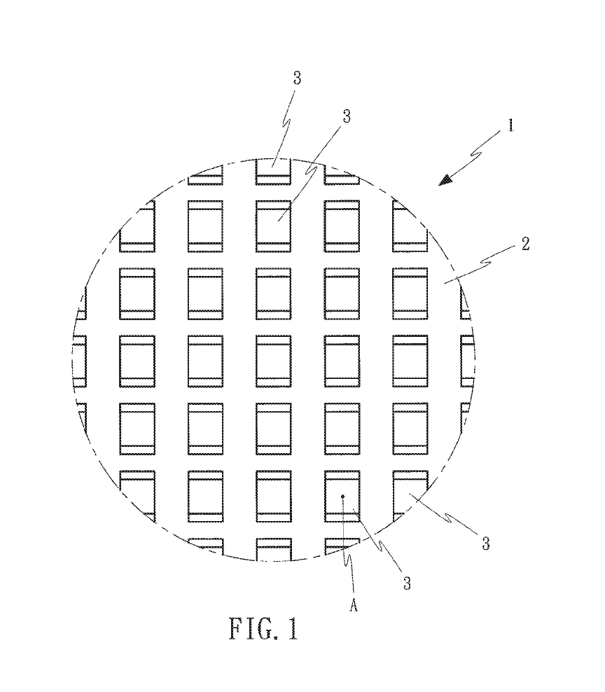

FIGS. 1 to 3 illustrate an anti-slip structure 1 in accordance with an embodiment of the present invention.

As shown in FIG. 1, the anti-slip structure 1 in accordance with the embodiment of the present invention comprises a base sheet 2 and a plurality of anti-slip units 3 disposed on the base sheet 2 at intervals in a matrix manner.

The base sheet 2 preferably is made of polyester material, while the anti-slip units 3 preferably are made of thermoplastic rubber (TPR) material and have a Shore A hardness of 38. In this regard, however, the present invention is not limited thereto, for example, the anti-slip units may also be made of the same TPR material, but has different hardness. Alternatively, the anti-slip units may also be made of thermoplastic polyurethane (TPU) material which can provide the anti-slip effect which will not be weakened due to water.

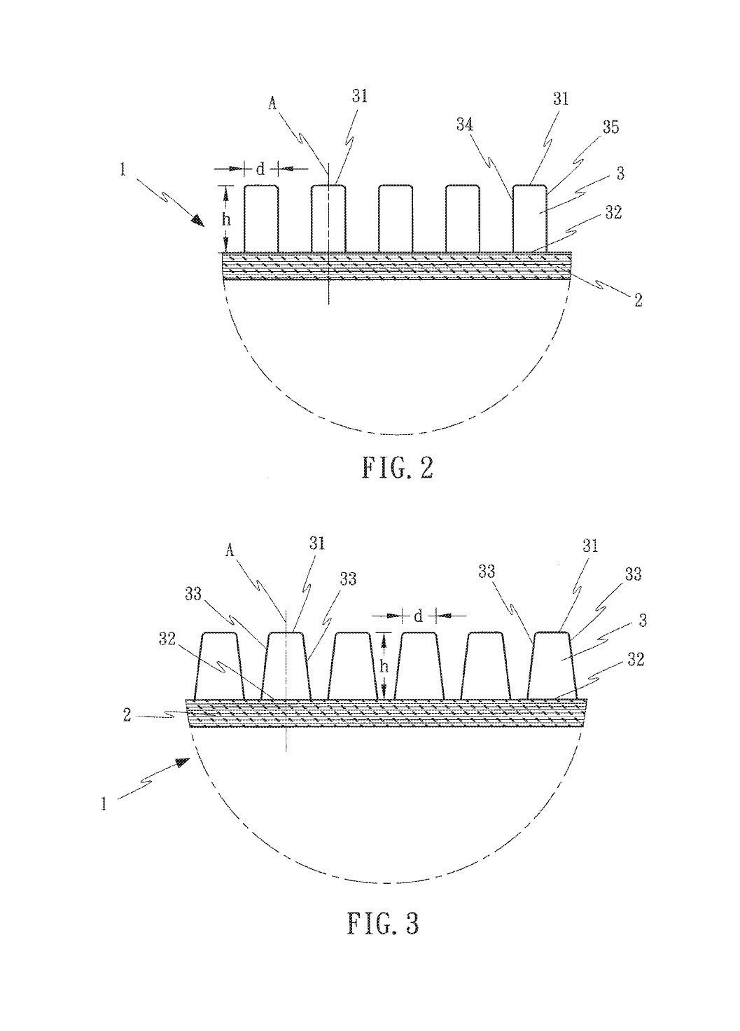

Next, referring to FIGS. 2 and 3, each of the anti-slip units 3 comprises a top surface 31, a bottom surface 32, two side surfaces 33, a front surface 34 and a back surface 35. The top surface 31 and the bottom surface 32 are concentrically disposed to be opposite to each other and are centered on a central axis A of the anti-slip unit 3. The top surface 31 is a planar surface having a substantial square shape (as shown in FIG. 1). The two side surfaces 33 are symmetrical to each other with respect to the central axis A and respectively extend obliquely from two opposite side edges of the top surface 31 outwardly toward two opposite side edges of the bottom surface 32. The front surface 34 and the back surface 35 respectively extend between the top surface 31, the bottom surface 32 and the two side surfaces 33. Preferably, each of the anti-slip units 3 has a height h of 0.5 mm, and a side of the square shape of the top surface 31 of each anti-slip unit 3 has a length d of 0.25 mm.

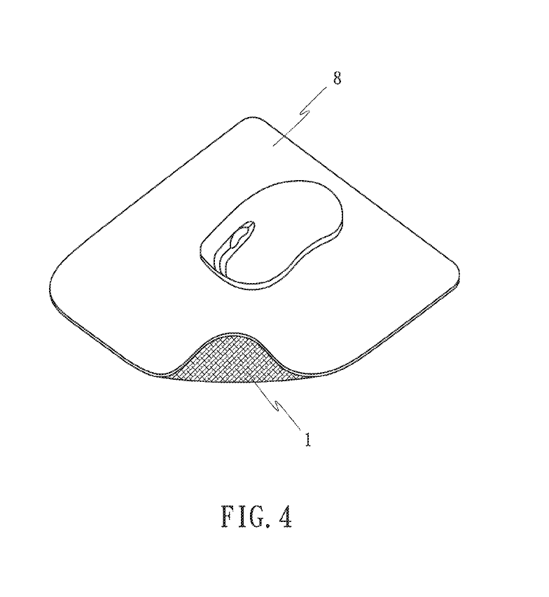

As shown in FIG. 4, the anti-slip structure 1 of the present invention can be applied to a contact surface of a mouse pad 8 (i.e., a back surface of the mouse pad 8) that is to be in contact with a surface of a desk so as to provide a good anti-slip effect in order to prevent the mouse pad from slipping during the mouse is moved thereon.

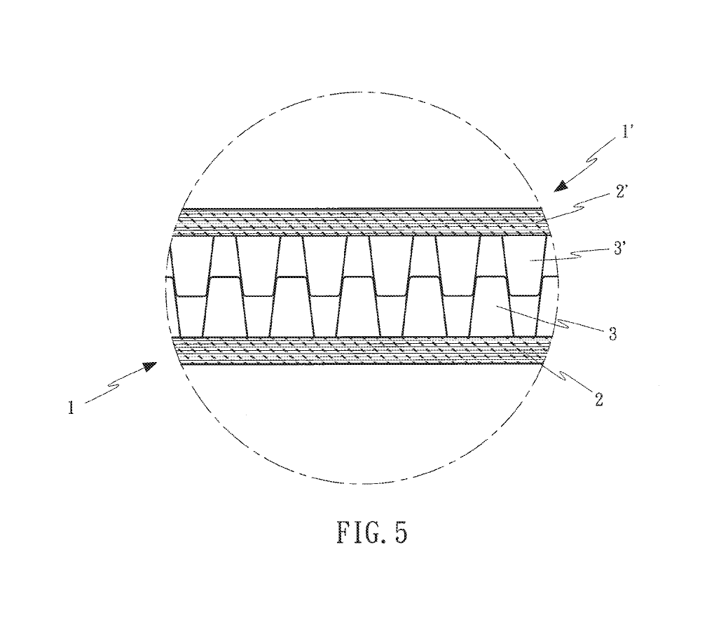

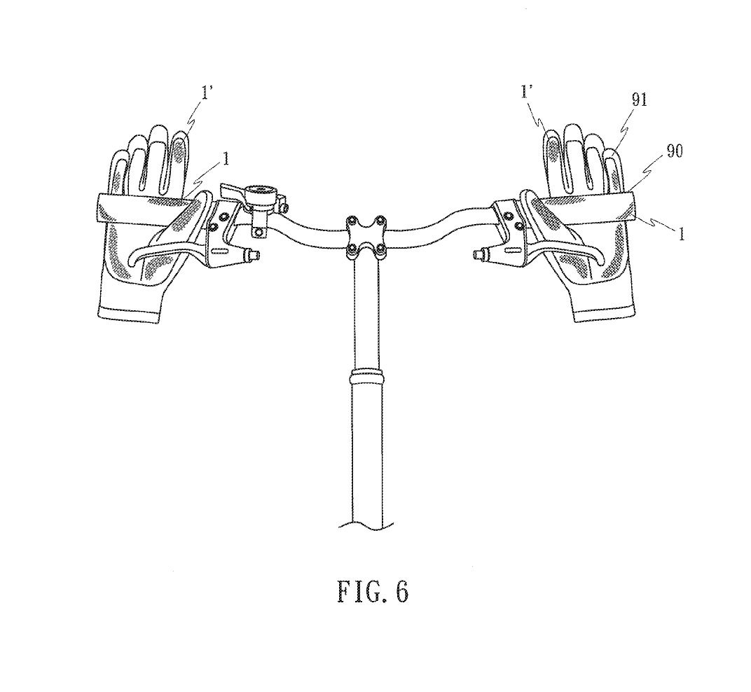

The anti-slip structure I in accordance with the present invention, in addition to being utilized independently to achieve the anti-slip effect with respect to another object (e.g., the surface of the desk) as discussed above, can also achieve the anti-slip effect by mutual engagements between the anti-slip units thereof and anti-slip units of another anti-slip structure. In the other word, as shown in FIG. 5, the plurality of anti-slip units 3 of the anti-slip structure 1 in accordance with the present invention are configured to be engageable with a plurality of anti-slip units 3′ of another anti-slip structure so as to achieve the anti-slip effect.

Said technical means to achieve the anti-slip effect by the mutual engagements between the anti-slip units 3, 3′ of the two anti-slip structure 1, can be specifically applied to a bicycle handlebar 90 and gloves 91 wore on a bicycle rider, as shown in FIG. 6. In this case, when the bicycle rider who wears the gloves 91 grabs the bicycle handlebar 90, the anti-slip units 3, 3′ of the two anti-slip structure 1, 1′ that are respectively disposed on the bicycle handlebar 90 and the gloves 91 can be engaged with each other (referring to FIG. 5) in order to prevent hands of the bicycle rider from slipping off the bicycle handlebar.

It should be understood that although the case that the two anti-slip structures are respectively applied to the bicycle handlebar and the gloves and used corporately is described above, yet the bicycle handlebar and the gloves each of which is provided with the anti-slip structure can also be used separately. That is, the user can use the bicycle handlebar provided with the anti-slip structure without wearing the gloves, or the user can grab the other object with hands wearing the gloves provided with the anti-slip structure.

In view of the abovementioned examples, it can be seen that the user may directly touch (or grab) the surface on which the anti-slip structure is disposed, and in this case, since the top surface of the anti-slip unit that has the square shape is planar and has a large surface area, it is possible to provide a better sense of touch to the user during use. Moreover, since the top surface of the anti-slip unit has the square shape, when the anti-slip structure is applied to a curve surface of the sports apparatus such as a grip of the ball stick, it is possible to prevent all of the anti-slip units from tilting down toward the same direction under the force such that the force-receiving surface of the anti-slip structure will not become a substantial planar surface and the anti-slip effect can therefore be maintained. In contrast, if the anti-slip structure has anti-slip units each of which has a rectangular top surface, when it is also applied to a curve surface, the plurality of anti-slip units may easily tilt down toward the same direction under the force such that the force-receiving surface of said anti-slip structure may become a substantial planar surface and the anti-slip effect thereof may be reduced.

Furthermore, since the anti-slip units of the anti-slip structure of the present invention are made of TPR (or TPU) material that has elasticity, in the case that the anti-slip structure is applied to the sports apparatus and thus is easily subjected an external force, the anti-slip structure can also achieve effects of buffering and vibration reduction.

On the other hand, in the anti-slip structure of the present invention, since the plurality of anti-slip units are disposed on the base sheet at intervals, gaps between said anti-slip units can provide an effect of water discharging such that when an object provided with the anti-slip structure is in contact with water, water can be discharged from the gaps between the anti-slip units, and thus, the anti-slip effect of the anti-slip structure will not be reduced.

Although in the abovementioned examples, the anti-slip structure of the present invention is applied to the mouse pad, the bicycle handlebar and the gloves, the present invention is not limited thereto. For example, the anti-slip structure of the present invention can also be applied to the other sports apparatus (e.g., a grip of a golf club or the like) or lifestyle products (e.g., a coaster or the like).

Although the several aspects of the present invention have been described in the abovementioned embodiments with reference to the accompanying drawings, such embodiments merely are the preferable embodiments of the present invention and are not intended to limit the scopes of the present invention into the specific features and structures as illustrated in the abovementioned descriptions and the accompanying drawings. A person skilled in the art of the present invention can envisage various changes and modifications within the spirit of the present invention, and such changes and modifications are also included in the scopes of the present invention.

The invention claimed is:

1. An anti-slip structure, comprising:
a base sheet; and
a plurality of anti-slip units disposed on the base sheet at intervals in a matrix manner, each of the anti-slip units having a central axis and comprising:
a top surface which is a planar surface having a substantial square shape that is centered on the central axis;
a bottom surface opposite to the top surface and centered on the central axis;
two side surfaces respectively extending obliquely from two opposite side edges of the top surface outwardly toward two opposite side edges of the bottom surface, the two side surfaces configured to be symmetrical to each other with respect to the central axis; and
front and back surfaces respectively extending between the top and bottom surfaces and the two side surfaces.

2. The anti-slip structure of claim 1, wherein the plurality of anti-slip units are made of thermoplastic rubber material.

3. The anti-slip structure of claim 2, wherein the plurality of anti-slip units have a Shore A hardness of 38.

4. The anti-slip structure of claim 1, wherein the base sheet is made of polyester material.

5. The anti-slip structure of claim 1, wherein each of the anti-slip units has a height of 0.5 mm.

6. The anti-slip structure of claim 1, wherein a side of the substantial square shape of the top surface has a length of 0.25 mm.

7. The anti-slip structure of claim 1, the plurality of anti-slip units of the anti-slip structure are configured to be engageable with a plurality of anti-slip units of another anti-slip structure.
